(19) United States
(12) Patent Application Publication
(10) Pub. No.: US 2021/0104335 A1
(43) Pub. Date: Apr. 8, 2021

(54) REAL-TIME MONITORING SYSTEM AND METHOD FOR AGRICULTURE AND LIVESTOCK FARMING BY USING IoT SENSOR

(71) Applicant: LABFIS CO.,LTD., Seongnam-si (KR)

(72) Inventors: Shin Dong HAN, Goyang-si (KR); Jeong Min LEE, Seoul (KR); Yeon Jeong WOO, Daegu (KR)

(73) Assignee: LABFIS CO.,LTD., Seongnam-si (KR)

(21) Appl. No.: 16/669,296

(22) Filed: Oct. 30, 2019

(30) Foreign Application Priority Data
Oct. 8, 2019 (KR) 10-2019-0124820

(51) Int. Cl. G16Y 20/40; G06Q 50/02; A01K 29/00; H04W 4/029; G16Y 10/05

(52) U.S. Cl. CPC G16Y 20/40; G06Q 50/02; G16Y 10/05; H04W 4/029; A01K 29/005

(57) ABSTRACT

The present invention relates to a real-time monitoring system and a real-time monitoring method for agriculture and livestock farming by using an IoT sensor, which are implemented in the agriculture and livestock farming to use the IoT sensor to detect a tag attached to a moving object and a Wi-Fi signal, and to use a livestock monitoring system (LMS) to monitor access to a virtual fence and an abnormal behavior of the moving object, and includes: generating a tag/Wi-Fi signal by a tag/Wi-Fi signal generator installed on a moving object; detecting, by an IoT sensor, the tag/Wi-Fi signal generated by the tag/Wi-Fi signal generator; and receiving, by an LMS unit, the tag/Wi-Fi signal detected by the IoT sensor to monitor access to a virtual fence and an abnormal behavior of the moving object.

### BACKGROUND OF THE INVENTION

### 1. Field of the Invention

The technical field of the present invention relates to a real-time monitoring system and a real-time monitoring method for agriculture and livestock farming by using an IoT sensor, and more particularly, to a real-time monitoring system and a real-time monitoring method for agriculture and livestock farming by using an IoT sensor, which are implemented in the agriculture and livestock farming to use the IoT sensor to detect a tag attached to a moving object (e.g., livestock, human, etc.) and a Wi-Fi signal, and to use a livestock monitoring system (LMS) to monitor access to a virtual fence and an abnormal behavior of the moving object.

### 2. Description of the Prior Art

In order to efficiently manage a large number of livestock raised in a stockyard of large-scale livestock farms, a livestock monitoring system adopts a technique of attaching a biometric RFID tag to each livestock, and reading information of the RFID tag through an RFID reader installed in the stockyard or at an entrance of the stockyard to identify a location of individual livestock whenever the livestock on which the RFID tag is attached passes into the stockyard or through the entrance of the stockyard. Such a livestock monitoring system simply identifies the location of the livestock through the biometric RFID tag and the RFID reader, and in many cases, the livestock monitoring system could not recognize when an abnormality occurs in the livestock or an environment where the livestock is located.

Korea Patent Registration No. 10-1194690 (registered on Oct. 19, 2012) discloses an apparatus for recognizing a location of livestock and a method thereof, in which when an abnormality occurs in livestock or an environment where the livestock is located, location information of the livestock is recognized through a measurement unit attached to the livestock, and a camera module is moved based on the recognized location information of the livestock to capture image information of the livestock, so that when an abnormality occurs, the location of the livestock is accurately recognized, and the image information of the livestock may be provided by using the recognized location information. According to the disclosed technology, the apparatus for recognizing the location of the livestock, which is connected to a first terminal attached to a head portion of the livestock to communicate through a Zigbee scheme to receive location information of the first terminal, and to transmit information for setting a moving route of a photographing unit to the photographing unit connected on a rail, includes: a communication unit configured to receive the location information of the first terminal transmitted from the first terminal and driving state information of a lighting unit included in the first terminal when a preset event occurs; and a control unit configured to transmit at least one of the received location information of the first terminal and location information transmitted from at least one arbitrary terminal to the photographing unit through the communication unit in order to set the moving route of the photographing unit when a received driving state of the lighting unit included in the first terminal is an ON state, wherein the first terminal recognizes the location information of the first terminal based on intensity of signals transmitted from a plurality of beacons.

Korean Patent Registration No. 10-0821888 (registered on Apr. 7, 2008) discloses a real-time livestock positioning system for a breeding farm including a plurality of stockyards, the real-time livestock positioning system including: a plurality of tags attached to each livestock with identification information for each object on each livestock; a plurality of readers configured to read the information from the tag, and transmit the identification information for each object read from the tag, location information of a corresponding reader, and a recognition time required for reading the information from the tag to an outside when the information is read from the tag; a control module configured to transmit and receive data with the reader and transmit the data received from the reader to the outside; and a central computer configured to receive the data from the reader through the control module to store and manage the received data, wherein the plurality of readers are provided in the stockyard, and the reader is provided at an entrance of each of a plurality of livestock rooms constituting the stockyard, wherein the reader provided at the entrance of the livestock room recognizes the tag of each object entering and exiting through the entrance to transmit information on the tag of each object recognized by the reader to an adjacent control module, and the plurality of readers provided in the stockyard recognize the tag of each object in the stockyard to transmit the recognized information on the tag of each object to the adjacent control module, and wherein the central computer extracts, stores, and manages current location information and moving route information for each livestock by using the identification information for each object, the location information of the corresponding reader, and information on the recognition time which are received from the control module. According to the disclosed technology, an RFID system and a wireless network may be used to inquire production history information for each livestock through a web by managing environment information for all stockyards in the breeding farm and managing all pieces of information for each object on all livestock, and to recognize the current location information for each object in real time.

In the related art as described above, technical schemes such as GPS and RFID are used in the case of a positioning technique available for applying livestock monitoring under a grazing environment. However, in the case of GPS, a detection period has to be set long due to high battery consumption, and it has been not easy to enter a market for large-scale livestock due to a high price point at which supply is performed to the market. In addition, in the case of RFID, while a chipset having a relatively low cost is used, since a reception distance is about 1 meter, a receiver has to be constructed very closely, so that it is not suitable for the use for monitoring purposes in outdoor environments such as grazing.

Accordingly, since the grazing is performed over a large area without separate fence boundaries in many cases of livestock breeding in a grazing environment, it is necessary to apply schemes for preventing a loss, such as monitoring on the livestock in livestock grazing areas, prevention of an escape from the grazing areas, and monitoring on outside invasion. In addition, the livestock industry is a field that is expected to greatly benefit from a combination of precise IoT and sensing technologies, and particularly, a large number of livestock have to be managed in large areas, so that low infrastructure construction costs and low maintenance costs are analyzed to be important success factors. To this end, it is necessary to develop a real-time platform capable of monitoring a location of livestock in real time, and recognizing and managing an escape from a monitoring area at a low cost through the convergence of various sensor technologies and IoT wireless Internet.

### DOCUMENTS OF RELATED ART

### Patent Documents

(Patent document 0001) Korean Patent Registration No. 10-1194690

(Patent document 0002) Korean Patent Registration No. 10-0821888

### SUMMARY OF THE INVENTION

An object of the present invention is to provide a real-time monitoring system and a real-time monitoring method for agriculture and livestock farming by using an IoT sensor, which are implemented in the agriculture and livestock farming to use the IoT sensor to detect a tag attached to a moving object (e.g., livestock, human, etc.) and a Wi-Fi signal, and to use a livestock monitoring system (LMS) to monitor access to a virtual fence and an abnormal behavior of the moving object.

To achieve the above object, according to one aspect of the present invention, there is provided a real-time monitoring system for agriculture and livestock farming by using an IoT sensor, the real-time monitoring system including: a tag/Wi-Fi signal generator installed on a moving object to generate a tag/Wi-Fi signal; an IoT sensor for detecting the tag/Wi-Fi signal generated by the tag/Wi-Fi signal generator; and a livestock monitoring system (LMS) unit for receiving the tag/Wi-Fi signal detected by the IoT sensor to monitor access to a virtual fence and an abnormal behavior of the moving object.

According to one embodiment, the tag/Wi-Fi signal generator includes a Bluetooth low energy (BLE) tag for tracking the moving object based on BLE 4.2 or higher.

According to one embodiment, the tag/Wi-Fi signal generator adopts a Bluetooth 5.0 module and a tag signal generation period algorithm so as to be used for a long time without replacing or recharging a battery.

According to one embodiment, the tag/Wi-Fi signal generator includes a Wi-Fi module for generating a Wi-Fi signal.

According to one embodiment, the tag/Wi-Fi signal generator operates in one or more schemes among: a scheme of transmitting multiple messages per second while the tag/Wi-Fi signal generator is connected to a Wi-Fi network; a scheme of attempting to search for the Wi-Fi network by a unit of a preset time while the tag/Wi-Fi signal generator is not connected to the Wi-Fi network; a scheme of attempting to search for a nearby IoT sensor and transmitting a signal for the searching every preset time when a location service is activated; and a scheme of randomly changing a media access control (MAC) address every preset time or whenever a significant change is detected in an environment.

According to one embodiment, the IoT sensor includes an IoT-based BLE and Wi-Fi signal listening sensor.

According to one embodiment, the IoT sensor includes a low energy Bluetooth-based tag and Wi-Fi signal listening sensor capable of detecting the Wi-Fi signal.

According to one embodiment, the IoT sensor finds a sampling period for optimizing a signal transmission period in the tag and a scanning period in the sensor in consideration of a distance between sensors of the virtual fence and power consumption, and samples a BLE signal according to the sampling period.

According to one embodiment, the IoT sensor receives a corresponding packet by using a passive scanning mode (PSM) to sample the BLE signal.

According to one embodiment, the IoT sensor performs communication by dividing a 2.4 GHz band into a total of 40 channels, and radiates an advertisement packet by using three channels as an advertising channel among the 40 channels.

According to one embodiment, the IoT sensor includes a Wi-Fi counter to decode a Wi-Fi channel by sampling a software receiver and search for a Wi-Fi activity of the tag/Wi-Fi signal generator.

According to one embodiment, the IoT sensor performs multiple detection with a time interval smaller than a parameter time in the same tag/Wi-Fi signal generator.

According to one embodiment, the IoT sensor measures the number of moving objects in a specific location, in which the IoT sensor measures the number of tag/Wi-Fi signal generators activated at a specific time modified by MAC randomization such that the tag/Wi-Fi signal generator using the MAC randomization is basically considered as ‘1’.

According to one embodiment, in sampling of the software receiver for decoding the Wi-Fi channel and searching for the Wi-Fi activity, the IoT sensor scans a frequency band for a preset time, waits for a preset time, examines all possible combinations of search keywords, and compares results with unsampled existing results in many scenarios, including a scenario similar to a target use case.

According to one embodiment, in the case of an algorithm for sampling the software receiver for decoding the Wi-Fi channel and searching for the Wi-Fi activity, the IoT sensor uses the data to perform determination related to a sampling rate, such that the IoT sensor reduces the sampling rate or a sampling ratio than before at a time zone when the activity is relatively very low, and compares results with a reference algorithm in scenarios with mutually different accuracies of each sampling algorithm and performance analysis on expected performance of the algorithm.

According to one embodiment, the IoT sensor performs time-based sampling and data-based sampling when executing the algorithm.

According to one embodiment, in the case of the time-based sampling when X is a sampling time and Y is an OFF time, the IoT sensor uses a time-based sampling algorithm to: operate for X seconds and enter a sleep mode for Y seconds; operate for X1 seconds, be turned off for Y1 seconds, and be turned on for X2 seconds until Xn; or receive a random value for N seconds regardless of Yn.

According to one embodiment, in the case of the data-based sampling, the IoT sensor uses a data-based sampling algorithm to perform determination related to the X and Y based on data found during an N detection round, and to reduce to Z % when a significant change is detected based on a previous number of tag/Wi-Fi signal generators during a final activation time.

According to one embodiment, the IoT sensor receives a Wi-Fi signal and transmits a response message when the tag/Wi-Fi signal generator transmits the Wi-Fi signal for each of the channels to use a network, and performs communication with the tag/Wi-Fi signal generator when the tag/Wi-Fi signal generator selects one channel.

According to one embodiment, the IoT sensor collects signals by changing channels in order to sense a signal of the tag/Wi-Fi signal generator, and processes and integrates replicated data per unit time including information on a MAC address, a chip manufacturer, and a time in the collected data into a desired data form to transmit the data to the LMS unit.

According to one embodiment, the IoT sensor periodically transmits a survival signal including information on a temperature, memory usage, and CPU usage to the LMS unit to determine whether the IoT sensor has an abnormality.

According to one embodiment, when the IoT sensor detects a wireless signal transmitted from the tag/Wi-Fi signal generator, the IoT sensor determines whether a preset data unit time has elapsed to generate a new unit time data set, determines whether a data set MAC address is duplicated when the data unit time has not elapsed or after the new unit time data set is generated, records detection information in the unit time data set when the data set MAC address is determined not to be duplicated, and determines whether a total data set size is equal to or greater than a preset transmission size to transmit the recorded detection information to the LMS unit.

According to one embodiment, the IoT sensor includes a data processing module to prepare data to be transmitted by processing the collected data, such that the IoT sensor filters the collected data based on a required time unit and transmits the filtered data without transmitting an entirety of the data collected from the tag/Wi-Fi signal generator.

According to one embodiment, the IoT sensor collects data having one identical MAC address and analyzes the collected data to collect data of a unit of milliseconds or more, such that the IoT sensor collects up to thousands of pieces of data having the identical MAC address within one second.

According to one embodiment, the IoT sensor applies a filtering algorithm to the data collected from the tag/Wi-Fi signal generator, such that the IoT sensor collects and integrates the identical MAC address within a specific time to obtain an integrated result.

According to one embodiment, the IoT sensor includes a data transmission module to transmit the collected data to a back-end system through an IoT WAN.

According to one embodiment, the IoT sensor uses a transmission and storage algorithm to extract and transmit only a required data field without transmitting the entirety of the data collected from the tag/Wi-Fi signal generator.

According to one embodiment, the IoT sensor determines a transmission period according to memory capacity, in which the IoT sensor performs transmission regardless of the transmission period when 1/n of a memory is occupied in consideration of a transmission failure, and applies a dynamic transmission period.

According to one embodiment, the LMS unit is provided with an algorithm for analyzing the access to the virtual fence and the abnormal behavior based on the tag/Wi-Fi signal to analyze the access to the virtual fence and the abnormal behavior of the moving object so as to construct a database of analyzed data, and to perform a real-time monitoring back-end function to analyze big data in the database so as to analyze or predict mobility of the moving object.

According to one embodiment, the LMS unit is provided with a real-time tracker including a moving route prediction function to track a moving route of the moving object based on current location information collected from the IoT sensor so as to monitor the moving route in real time and analyze a moving pattern.

According to one embodiment, the LMS unit uses a trajectory data mining scheme using at least one of a trajectory data clustering-based algorithm, a trajectory data classification-based algorithm, and a trajectory association rule-based algorithm to analyze the moving route of the moving object so as to extract a moving route pattern.

According to one embodiment, the LMS unit uses a pattern mining module of the trajectory association rule-based algorithm and a route prediction module to analyze frequent moving route patterns of moving objects entering a location while moving in a specific region so as to predict a next visiting location or route.

According to one embodiment, the LMS unit extracts the moving route pattern by executing the pattern mining module, such that the LMS unit converts a location of the moving object into a continuous trajectory to determine whether an error occurs and perform outlier filtering, classifies a cluster based on a starting point and an arrival point (or vice versa) by using a forward backward matching (FBM) scheme, and extracts the moving route pattern for each cluster.

According to one embodiment, the LMS unit is provided with a route prediction model to predict the next visiting location or estimate the next route of the moving object based on the moving route pattern extracted through the pattern mining module.

According to one embodiment, the LMS unit divides the moving route pattern extracted through the pattern mining module into a training set and a test set, trains a model with the training set, verifies an accuracy of the model with the test set, and returns a moving prediction location as a result when a moving location set of the moving object is transmitted as an input variable of the route prediction model.

According to one embodiment, the LMS unit is provided with a big data analysis module for real-time monitoring to perform real-time data collection, storage, and processing, in which the LMS unit collects a large amount of scanning data and sensor state information, performs data cleansing, normalization, and verification on the collected data, performs normalization and preprocessing to efficiently process massive data, performs preprocessing on the moving route and the data of the moving object, and extracts descriptive statistics of the preprocessed data to obtain real-time route analysis data and moving route prediction data.

According to one embodiment, the LMS unit visualizes an analysis result through a heat map in real-time monitoring graphs and maps, such that the LMS unit expresses the analysis result in a heat map and a congestion grid scheme for each sensor, or with a real-time staying object and moving route analysis.

To achieve the above object, according to another aspect of the present invention, there is provided a real-time monitoring method for agriculture and livestock farming by using an IoT sensor, the real-time monitoring method including: generating a tag/Wi-Fi signal by a tag/Wi-Fi signal generator installed on a moving object; detecting, by an IoT sensor, the tag/Wi-Fi signal generated by the tag/Wi-Fi signal generator; and receiving, by an LMS unit, the tag/Wi-Fi signal detected by the IoT sensor to monitor access to a virtual fence and an abnormal behavior of the moving object.

As effects of the present invention, there are provided the real-time monitoring system and the real-time monitoring method for the agriculture and livestock farming by using the IoT sensor, which are implemented in the agriculture and livestock farming to use the IoT sensor to detect the tag attached to the moving object (e.g., livestock, human, etc.) and the Wi-Fi signal, and to use the livestock monitoring system (LMS) to monitor the access to the virtual fence and the abnormal behavior of the moving object, so that even in the case of the positioning technique available for applying the livestock monitoring under the grazing environment, the detection period can be set short by reducing battery consumption, it can be easy to enter the market for large-scale livestock due to a low price point at which the supply is performed to the market, and the receiver can be sparsely distributed due to a long reception distance so that it can be suitable for the use for monitoring purposes in the outdoor environments such as grazing.

According to the present invention, even if the grazing is performed over a large area without the separate fence boundaries in many cases of the livestock breeding in the grazing environment, schemes for preventing a loss, such as monitoring on the livestock in livestock grazing areas, prevention of an escape from the grazing areas, and monitoring on outside invasion can be easily applied. In addition, even if the livestock industry is a field that is expected to greatly benefit from a combination of precise IoT and sensing technologies, and particularly, a large number of livestock is managed in large areas, the management can be performed at low infrastructure construction costs and low maintenance costs. To this end, the monitoring for the location of the livestock in real time and the recognition and management for the escape from the monitoring area can be performed at a low cost through the convergence of various sensor technologies and IoT wireless Internet.

### BRIEF DESCRIPTION OF THE DRAWINGS

FIG. 1 is a view for describing a real-time monitoring system for agriculture and livestock farming by using an IoT sensor according to an embodiment of the present invention.

FIG. 2 is a view for describing a tag signal detected by the IoT sensor shown in FIG. 1.

FIG. 3 is a view for describing characteristics of Wi-Fi frequency bands and channels detected by the IoT sensor shown in FIG. 1.

FIG. 4 is a view for describing a detection control of the IoT sensor shown in FIG. 1.

FIG. 5 is a view for describing an example of filtering collected data of the IoT sensor shown in FIG. 1.

FIG. 6 is a view for describing a real-time monitoring method for agriculture and livestock farming by using an IoT sensor according to an embodiment of the present invention.

### DETAILED DESCRIPTION OF THE EXEMPLARY EMBODIMENTS

Hereinafter, embodiments of the present invention will be described in detail with reference to the accompanying drawings so that a person having ordinary skill in the art to which the invention pertains may easily implement the present invention. However, the description of the present invention is merely an embodiment for structural or functional explanation, so the scope of the present invention shall not be construed as being limited to the embodiments disclosed in the specification. In other words, since various modifications can be made to the embodiments, and the embodiments may have various other forms, it shall be understood that the scope of the present invention encompasses equivalents for implementing the technical idea. In addition, all the objects or effects addressed in the present disclosure are not intended to be included in a specific embodiment, and the embodiments are not intended to include only such effects, so the scope of the present invention shall not be understood as being limited by the objects or effects.

Terms described in the present disclosure may be understood as follows.

Terms such as “first” and “second” are intended to distinguish one component from another component, and the scope of rights shall not be limited by these terms. For example, a first component may be referred to as a second component, and similarly, a second component may be referred to as a first component. It shall be understood that when one component is referred to as being “connected” to another component, the component may be directly connected to the other component, or intervening components may also be present. In contrast, it shall be understood that when one component is referred to as being “directly connected” to another component, no intervening elements are present. Meanwhile, other expressions describing the relationship between the components, such as “between” and “immediately between” or “adjacent to” and “directly adjacent to”, shall be interpreted similarly.

Unless the context explicitly indicates otherwise, it shall be understood that expressions in a singular form include a meaning of a plural form. In addition, the term such as “comprising” or “including” is intended to designate the presence of characteristics, numbers, steps, operations, elements, parts, or combinations thereof disclosed in the specification, and shall not be construed to preclude any possibility of presence or addition of one or more other characteristics, numbers, steps, operations, elements, parts, or combinations thereof.

Unless defined otherwise, all terms used herein have the same meanings as how they are generally understood by a person having ordinary skill in the art to which the invention pertains. Any terms as those defined in a general dictionary shall be construed to have meanings identical to the contextual meanings in the relevant art, and, unless explicitly defined otherwise in the present disclosure, shall not be construed to have idealistic or excessively formalistic meanings.

Hereinafter, a real-time monitoring system and a real-time monitoring method for agriculture and livestock farming by using an IoT sensor according to an embodiment of the present invention will be described in detail with reference to the accompanying drawings.

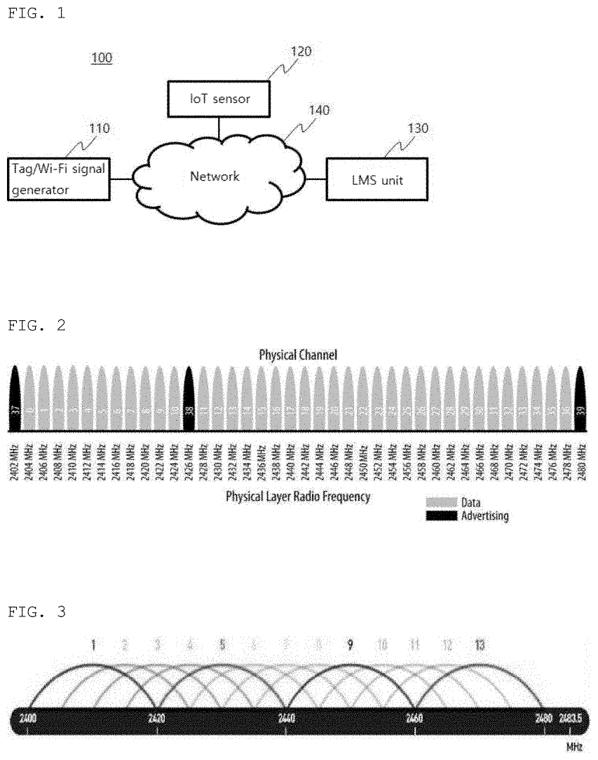

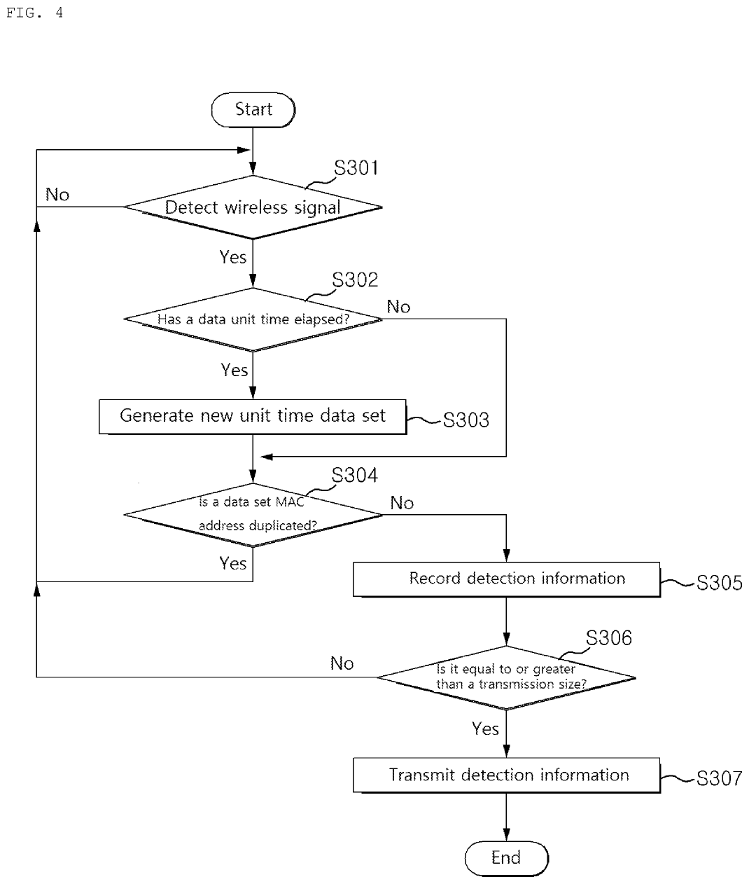

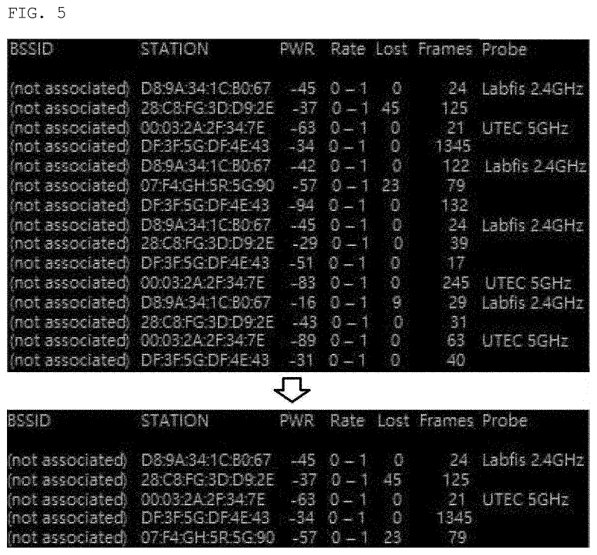

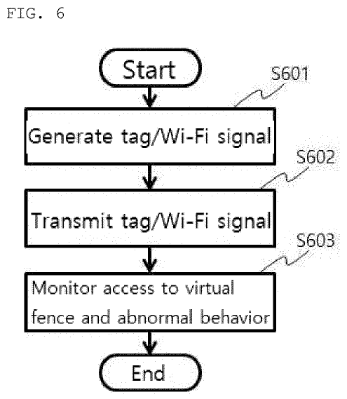

FIG. 1 is a view for describing a real-time monitoring system for agriculture and livestock fainting by using an IoT sensor according to an embodiment of the present invention, FIG. 2 is a view for describing a tag signal detected by the IoT sensor shown in FIG. 1, FIG. 3 is a view for describing characteristics of Wi-Fi frequency bands and channels detected by the IoT sensor shown in FIG. 1, FIG. 4 is a view for describing a detection control of the IoT sensor shown in FIG. 1, and FIG. 5 is a view for describing an example of filtering collected data of the IoT sensor shown in FIG. 1.

Referring FIGS. 1 to 5, a real-time monitoring system 100 for agriculture and livestock farming by using an IoT sensor includes a plurality of tag/Wi-Fi signal generator 110, a plurality of IoT sensors 120, a livestock monitoring system (LMS) unit 130, and a network 140.

The tag/Wi-Fi signal generator 110 is attached (or installed) to a moving object (e.g., livestock, human, etc.), and generates a tag/Wi-Fi signal to and transmit the tag/Wi-Fi signal to the IoT sensor 120.

According to one embodiment, the tag/Wi-Fi signal generator 110 may include a Bluetooth low energy (BLE) tag for tracking the moving object based on BLE 4.2 or higher.

According to one embodiment, the tag/Wi-Fi signal generator 110 adopts a Bluetooth 5.0 module while optimizing the tag signal generation period algorithm in the case of a BLE smart tag, so that an excellent service life may be implemented so as to be without replacing or recharging a battery for 6 months to 1 year, high price competitiveness may be ensured at a level of about $10 (mass production price of $5), and performance may be improved with a high sensing accuracy per price of about 80% or more in comparison with a conventional GPS scheme.

According to one embodiment, when the tag/Wi-Fi signal generator 110 includes a Wi-Fi module for generating a Wi-Fi signal, in order to significantly reduce power consumption, the tag/Wi-Fi signal generator 110 may operate in one or more schemes among: a scheme of transmitting a preset number of messages (multiple messages) per second while the tag/Wi-Fi signal generator 110 is connected to a Wi-Fi network; a scheme of attempting to search for the Wi-Fi network by a unit of a preset time (e.g., about 10 to 20 seconds) while the tag/Wi-Fi signal generator 110 is not connected to the Wi-Fi network; a scheme of attempting to search for a nearby IoT sensor 120 and transmitting a signal for the searching every preset time (e.g., about 20 to 60 seconds, while the preset time may vary depending on many factors) to improve a location accuracy when a location service is activated; and a scheme of randomly changing a media access control (MAC) address every preset time (e.g., 50 minutes) or whenever a significant change is detected in an environment in the case of iOS.

The IoT sensor 120 may detect the tag/Wi-Fi signal transmitted from the tag/Wi-Fi signal generator 110 and transmit the detected tag/Wi-Fi signal to the LMS unit 130.

According to one embodiment, the IoT sensor 120 may include an IoT-based BLE and Wi-Fi signal listening sensor which is operable with a low power, which is a BLE/Wi-Fi signal listening sensor (BLE & Wi-Fi signal listening sensor) capable of detecting a tag and a Wi-Fi signal based on low energy Bluetooth.

According to one embodiment, in the case of a BLE signal, the IoT sensor 120 may find a sampling period for optimizing a signal transmission period in the smart tag and a scanning period in the sensor in consideration of a distance between sensors of the virtual fence and the power consumption and sample the BLE signal according to the sampling period, and may receive a corresponding packet by using a passive scanning mode (PSM) to sample the BLE signal. In addition, as shown in FIG. 2, the IoT sensor 120 may perform communication by dividing a 2.4 GHz band into a total of 40 channels, and radiates an advertisement packet by using three channels 37 to 39 as advertising channels among the 40 channels.

According to one embodiment, the IoT sensor 120 may include a Wi-Fi counter to decode a Wi-Fi channel (e.g., three channels per second) by sampling a software receiver and search for a Wi-Fi activity of the tag/Wi-Fi signal generator 110 by using the Wi-Fi counter, may perform multiple detection with a time interval smaller than a parameter time (e.g., 5 to 30 minutes) in the same tag/Wi-Fi signal generator 110, and may measure the number of moving objects in a specific location (i.e., the number of tag/Wi-Fi signal generators 110 activated at a specific time modified by MAC randomization such that the tag/Wi-Fi signal generator 110 using the MAC randomization is basically considered as ‘1’).

According to one embodiment, in sampling of the software receiver for decoding the Wi-Fi channel and searching for the Wi-Fi activity, the IoT sensor 120 may, for example, scan a frequency band for a preset time (e.g., one minute), wait for a preset time (e.g., one minute), examine all possible combinations of search keywords, and compare results with unsampled existing results in many scenarios, including a scenario similar to a target use case, so that a sampling rate can be efficiently reduced.

According to one embodiment, the IoT sensor 120 may be provided with an algorithm for sampling the software receiver for decoding the Wi-Fi channel and searching for the Wi-Fi activity, may use the data to perform determination related to the sampling rate in the case of an algorithm for optimal performance, may reduce the sampling rate (or a sampling ratio) than before at a time zone when the activity is relatively very low (e.g., at late night), and may compare results with a reference algorithm in scenarios with mutually different accuracies of each sampling algorithm and performance analysis on expected performance of the algorithm.

According to one embodiment, the IoT sensor 120 may perform time-based sampling and data-based sampling when executing the algorithm.

According to one embodiment, in the case of the time-based sampling, the IoT sensor 120 may use a time-based sampling algorithm to: operate for X seconds and enter a sleep mode for Y seconds; operate for X1 seconds, be turned off for Y1 seconds, and be turned on for X2 seconds until Xn; or receive a random value for N seconds regardless of Yn. In this case, X is a sampling time, and Y is an OFF time.

According to one embodiment, in the case of the data-based sampling, the IoT sensor 120 may use a data-based sampling algorithm to perform determination related to the X and Y based on data found during an N detection round, and to reduce, for example, to Z % when a significant change is detected based on a previous number of tag/Wi-Fi signal generators 110 during a final activation time. In this case, the data-based sampling algorithm may consider the number of detections and a change in the number of detections as main determination variables.

According to one embodiment, the IoT sensor may receive a Wi-Fi signal and transmit a response message when the tag/Wi-Fi signal generator 110 transmits the Wi-Fi signal for each of the channels 1 to 13 to use the network 140, and may perform communication with the tag/Wi-Fi signal generator 110 when the tag/Wi-Fi signal generator 110 selects one channel. In this case, according to characteristics of frequency bands and channels of the Wi-Fi signal, as shown in FIG. 3, 13 channels are used for actual data communication in 802.11n-based Wi-Fi communication using a 2.4 GHz frequency band, and a bandwidth interval between adjacent channels is 5 MHz, in which four channels that do not overlap each other are channels Nos. 1, 5, 9, and 13.

According to one embodiment, the IoT sensor 120 may collect signals by changing channels (e.g., 1, 5, 9, 13, 2, 6, etc.) in order to sense a signal of the tag/Wi-Fi signal generator 110, and may process and integrate replicated data per unit time including information on a MAC address, a chip manufacturer, a time, and the like in the collected data into a desired data form to transmit the data to the LMS unit 130. In addition, the IoT sensor 120 may periodically transmit a survival signal (including information on a temperature, memory usage, CPU usage, etc.) to a database of the LMS unit 130 to determine whether the IoT sensor 120 has an abnormality.

According to one embodiment, as shown in FIG. 4, when the IoT sensor 120 detects a wireless signal transmitted from the tag/Wi-Fi signal generator 110 (S301), the IoT sensor 120 may determine whether a preset data unit time has elapsed (S302), generate a new unit time data set when the data unit time has elapsed (S202), determine whether a data set MAC address is duplicated when the data unit time has not elapsed or after the new unit time data set is generated (S304), return to operation S301 described above when the data set MAC address is determined to be duplicated while recording detection information in the unit time data set when the data set MAC address is determined not to be duplicated (S305), determine whether a total data set size is equal to or greater than a preset transmission size (S306), and return to operation S301 described above when the total data set size is not equal to or greater than the preset transmission size while transmitting the recorded detection information to the LMS unit 130 when the total data set size is equal to or greater than the preset transmission size (S307).

According to one embodiment, the IoT sensor 120 may include a data processing module, and may prepare data to be transmitted by processing the collected data by using the data processing module, such that the IoT sensor 120 may filter the collected data based on a required time unit and transmit the filtered data without transmitting an entirety of the data collected from the tag/Wi-Fi signal generator 110. For example, when assuming that one tag/Wi-Fi signal generator 110 for watching a video is provided, the IoT sensor 120 may collect data having one identical MAC address and analyze the collected data to collect data of a unit of milliseconds or more, that is, the IoT sensor 120 may collect up to thousands of pieces of data having the identical MAC address within one second. In this case, referring to an example of filtering the collected data, as shown in FIG. 5, an upper portion shows the data collected by the IoT sensor 120, and a lower portion shows an integrated result obtained by applying a filtering algorithm to the collected data to integrate the data when the identical MAC address is collected within a specific time. In this case, STATION denotes a MAC address, PWR denotes signal intensity, Rate denotes a supported wireless speed which is reported by a device, Lost denotes the number of times the device is disconnected from Wi-Fi, and Frames denotes the number of detected frames.

According to one embodiment, the IoT sensor 120 may include a data transmission module (e.g., LoRa, LTE-M, and NB-IoT modules, etc.), and may transmit the collected data to a back-end system through an IoT WAN of the network 140 by using the data transmission module. In this case, the IoT sensor 120 may use a transmission and storage algorithm to extract and transmit only a required data field without transmitting the entirety of the collected data, so that the number of pieces of data transmitted at one time can be increased while consuming the same power and data, and a transmission period (e.g., a unit of 10 seconds) can be determined according to memory capacity, in which transmission may be performed regardless of the transmission period (condition) when 1/n of a memory is occupied in consideration of a transmission failure, and a dynamic transmission period may be applied.

The LMS unit 130 may receive the tag/Wi-Fi signal transmitted from the IoT sensor 120 to monitor access to a virtual fence and an abnormal behavior of the moving object.

According to one embodiment, the LMS unit 130 may be provided with an algorithm for analyzing the access to the virtual fence and the abnormal behavior based on the tag/Wi-Fi signal to analyze the access to the virtual fence and the abnormal behavior of the moving object so as to construct a database of analyzed data (i.e., data obtained by analyzing the access to the virtual fence and the abnormal behavior of the moving object), and to perform a real-time monitoring back-end function to analyze big data in the database so as to analyze or predict mobility of the moving object.

According to one embodiment, the LMS unit 130 may perform multi-monitoring, such that the LMS unit 130 may simultaneously perform an outside invasion monitoring (security) function as well as a livestock monitoring function by using one sensor infrastructure through the IoT sensor 120 that is a multi-sensor equipped with a Wi-Fi signal sensing function as well as a Bluetooth sensing function.

According to one embodiment, the LMS unit 130 may be provided with a real-time tracker including a moving route prediction function, and may monitor a moving route in real time and analyze a moving pattern with a function of tracking a moving route of livestock (or invader) based on current location information collected from the IoT sensor 120 by using the real-time tracker.

According to one embodiment, the LMS unit 130 may analyze the moving route of the moving object upon moving route prediction so as to extract a moving route pattern. At this time, the LMS unit 130 may use trajectory data mining schemes upon the moving route prediction, and may use a trajectory data clustering-based algorithm, a trajectory data classification-based algorithm, a trajectory association rule-based algorithm, or the like.

According to one embodiment, the LMS unit 130 may use a pattern mining module of the trajectory association rule-based algorithm, which is an algorithm that defines point (or region) information with numerically-high relevance (frequency of simultaneous or continuous occurrence) as association relation and searches for a frequency and relevance for the information, and may use a route prediction module, to analyze frequent moving route patterns of moving objects entering a location while moving in a specific region so as to predict a ‘next visiting location or route’.

According to one embodiment, the LMS unit 130 may extract the moving route pattern by executing the pattern mining module. At this time, a process of the pattern mining module may include a first operation of converting a location of the moving object into a continuous trajectory to determine whether an error occurs and perform outlier filtering, a second operation of classifying a cluster based on a starting point and an arrival point (or vice versa) by using a forward backward matching (FBM) scheme, and a third operation of extracting the moving route pattern for each cluster.

According to one embodiment, the LMS unit 130 may use a route prediction model to predict the next visiting location (or estimate the next route) of the moving object by using the moving route pattern extracted as described above. In addition, the LMS unit 130 may select and execute an algorithm in which a model has the highest accuracy by using a model such as decision tree, kNN, and DBN as the route prediction model. At this time, the LMS unit 130 may approach a classification issue of estimating the moving route through prediction of the next visiting location based on the moving route pattern extracted through the pattern mining module.

According to one embodiment, upon execution of the route prediction model, the LMS unit 130 may perform a first operation of dividing the moving route pattern extracted through the pattern mining module into a training set and a test set, a second operation of training a model with the training set and verifying an accuracy of the model with the test set, and a third operation of returning a moving prediction location as a result when a moving location set of the moving object is transmitted as an input variable of the route prediction model.

According to one embodiment, the LMS unit 130 may be provided with a big data analysis module for real-time monitoring to perform real-time data collection, storage, and processing, in which the LMS unit 130 may collect a large amount of scanning data and sensor state information, perform data cleansing, normalization, and verification on the collected data, perform normalization and preprocessing to efficiently process massive data, perform preprocessing on the moving route and the data of the moving object, and extract descriptive statistics of the preprocessed data to obtain real-time route analysis data and moving route prediction data.

According to one embodiment, the LMS unit 130 may visualize an analysis result through a heat map in real-time monitoring graphs and maps. At this time, the LMS unit 130 may express the analysis result in a heat map and a congestion grid scheme for each sensor, or with a real-time staying object and moving route analysis.

The network 140 may include a wired or wireless communication network, and may allow wired or wireless communication between the tag/Wi-Fi signal generators 110 and the IoT sensors 120, or wired or wireless communication between the IoT sensors 120 and the LMS unit 130 so as to transmit and receive data between the tag/Wi-Fi signal generators 110 and the IoT sensors 120 or data between the IoT sensors 120 and the LMS unit 130.

The real-time monitoring system 100 for the agriculture and livestock farming by using the IoT sensor, which has the configuration as described above, is implemented in the agriculture and livestock farming to use the IoT sensor 230 to detect the tag, which is attached to the moving object, and the Wi-Fi signal of the tag/Wi-Fi signal generator 110 and use the LMS unit 130 to monitor the access to the virtual fence and the abnormal behavior of the moving object, so that even in the case of a positioning technique available for applying the livestock monitoring under a grazing environment, a detection period can be set short by reducing battery consumption, it can be easy to enter a market for large-scale livestock due to a low price point at which supply is performed to the market, and a receiver can be sparsely distributed due to a long reception distance so that it can be suitable for the use for monitoring purposes in outdoor environments such as grazing.

Even if the grazing is performed over a large area without the separate fence boundaries in many cases of the livestock breeding in the grazing environment, the real-time monitoring system 100 for the agriculture and livestock farming by using the IoT sensor, which has the configuration as described above, can easily adopt schemes for preventing a loss, such as monitoring on the livestock in livestock grazing areas, prevention of an escape from the grazing areas, and monitoring on outside invasion. In addition, even if the livestock industry is a field that is expected to greatly benefit from a combination of precise IoT and sensing technologies, and particularly, a large number of livestock is managed in large areas, the real-time monitoring system 100 for the agriculture and livestock farming by using the IoT sensor, which has the configuration as described above, can perform the management at low infrastructure construction costs and low maintenance costs. To this end, the real-time monitoring system 100 can perform the monitoring for the location of the livestock in real time and the recognition and management for the escape from the monitoring area at a low cost through the convergence of various sensor technologies and IoT wireless Internet.

Even under environments where it is difficult to connect a wired network with a power supply of a device for preventing a loss of livestock, detecting an intruder, and analyzing floating population in real time, the real-time monitoring system 100 for the agriculture and livestock farming by using the IoT sensor, which has the configuration as described above, may construct IoT-based low-power wireless signal sensing hardware and software, so that the real-time monitoring system 100 can be used in smart buildings in a smart city field, a smart transportation field, and fields of smart retail, smart tourism, smart security and safety, and the like as well as a smart agriculture field, an energy saving effect can be expected through low-cost and low-power consumption technologies. Accordingly, competitiveness of agriculture and stockbreeding industries can be increased through the convergence of agriculture and ICT, creation of an added value can be expected through automation, an industrial association effect can be expected, rural economy can be revitalized, and it is possible to lead big data-based researches and industries through constructing a general purpose platform for various fields.

The real-time monitoring system 100 for the agriculture and livestock farming by using the IoT sensor, which has the configuration as described above, may use a low-power chipset based on Bluetooth 5.0 in the tag/Wi-Fi signal generator 110, so that the real-time monitoring system 100 can be used for about 6 months to 1 year without replacing or recharging a battery, the smart tag can be easily managed throughout a whole course of life cycle of livestock from birth to butchery, production can be performed inexpensively at an actual mass production price of $5 so as to meet requirements due to characteristics of a market in which large-scale livestock have to be monitored, and an infrastructure can be constructed at a relatively low cost due to a signal range wider than a signal range of Bluetooth 4.2 in constructing sensors for a virtual geofencing configuration.

Since there are many environmental factors without external fences in the case of livestock breeding through grazing, the real-time monitoring system 100 for the agriculture and livestock farming by using the IoT sensor, which has the configuration as described above, can detect livestock escaping the grazing area in real time and prevent theft due to invasion of outsiders. In this case, a multi-monitoring function capable of simultaneously providing an outside invasion monitoring (security) function as well as a livestock monitoring function can be provided by using one sensor infrastructure through the tag/Wi-Fi signal generator 110 that is a multi-sensor equipped with a Wi-Fi signal sensing function as well as a Bluetooth sensing function.

FIG. 6 is a view for describing a real-time monitoring method for agriculture and livestock farming by using an IoT sensor according to an embodiment of the present invention.

Referring to FIG. 6, the tag/Wi-Fi signal generator 110 attached (or installed) to a moving object (e.g., livestock, human, etc.) (or carried by a person) may generate the tag/Wi-Fi signal to transmit the tag/Wi-Fi signal to the IoT sensor 120 (S601).

When generating the tag/Wi-Fi signal in operation S601 described above, the tag/Wi-Fi signal generator 110 may include the BLE tag for tracking the moving object based on BLE 4.2 or higher to generate a tag signal.

When generating the tag/Wi-Fi signal in operation S601 described above, the tag/Wi-Fi signal generator 110 may be provide with the Bluetooth 5.0 module with a high sensing accuracy per price and an optimized tag signal generation period algorithm, so that a signal of the BLE smart tag may be generated from 6 months to 1 year without replacing or recharging a battery.

When generating the tag/Wi-Fi signal in operation S601 described above, the tag/Wi-Fi signal generator 110 may include the Wi-Fi module for generating the Wi-Fi signal, so that the tag/Wi-Fi signal generator 110 may operate in one or more schemes among: a scheme of transmitting a preset number of messages (multiple messages) per second while the tag/Wi-Fi signal generator 110 is connected to a Wi-Fi network; a scheme of attempting to search for the Wi-Fi network by a unit of a preset time (e.g., about 10 to 20 seconds) while the tag/Wi-Fi signal generator 110 is not connected to the Wi-Fi network; a scheme of attempting to search for a nearby IoT sensor 120 and transmitting a signal for the searching every preset time (e.g., about 20 to 60 seconds, while the preset time may vary depending on many factors) to improve a location accuracy when a location service is activated; and a scheme of randomly changing a media access control (MAC) address every preset time (e.g., 50 minutes) or whenever a significant change is detected in an environment in the case of iOS.

When the tag/Wi-Fi signal is generated in operation S601 described above, the IoT sensor 120 may detect the tag/Wi-Fi signal transmitted from the tag/Wi-Fi signal generator 110 and transmit the detected tag/Wi-Fi signal to the LMS unit 130 (S602).

When transmitting the tag/Wi-Fi signal in operation S602 described above, the IoT sensor 120 may include the IoT-based BLE and Wi-Fi signal listening sensor which is operable with a low power, so that in the case of the BLE signal, the IoT sensor 120 may find the sampling period for optimizing the signal transmission period in the smart tag and the scanning period in the sensor in consideration of the distance between sensors of the virtual fence and the power consumption and sample the BLE signal according to the sampling period, and may receive the corresponding packet by using the PSM to sample the BLE signal.

When transmitting the tag/Wi-Fi signal in operation S602 described above, the IoT sensor 120 may include the BLE/Wi-Fi signal listening sensor (BLE & Wi-Fi signal listening sensor) capable of detecting the tag and the Wi-Fi signal based on the low energy Bluetooth, so that in the case of the BLE signal, the communication may be performed by dividing the 2.4 GHz band into a total of 40 channels, and the advertisement packet may be radiated by using three channels 37 to 39 (i.e., advertising channels) among the 40 channels.

When transmitting the tag/Wi-Fi signal in operation S602 described above, the IoT sensor 120 may include the Wi-Fi counter to decode the Wi-Fi channel (e.g., three channels per second) by sampling the software receiver and search for the Wi-Fi activity of the tag/Wi-Fi signal generator 110, to perform the multiple detection with a time interval smaller than the parameter time (e.g., 5 to 30 minutes) in the same tag/Wi-Fi signal generator 110, and to measure the number of moving objects in a specific location (i.e., the number of tag/Wi-Fi signal generators 110 activated at a specific time modified by MAC randomization such that the tag/Wi-Fi signal generator 110 using the MAC randomization is basically considered as ‘1’).

When transmitting the tag/Wi-Fi signal in operation S602 described above, upon the sampling of the software receiver for decoding the Wi-Fi channel and searching for the Wi-Fi activity, the IoT sensor 120 may, for example, scan a frequency band for a preset time (e.g., one minute), wait for a preset time (e.g., one minute), examine all possible combinations of search keywords, and compare results with unsampled existing results in many scenarios, including a scenario similar to the target use case, so that the sampling rate can be efficiently reduced.

When transmitting the tag/Wi-Fi signal in operation S602 described above, the IoT sensor 120 may be provided with the algorithm for sampling the software receiver for decoding the Wi-Fi channel and searching for the Wi-Fi activity to use the data to perform the determination related to the sampling rate, to reduce the sampling rate (or the sampling ratio) than before at a time zone when the activity is relatively very low (e.g., at late night), and to compare results with the reference algorithm in the scenarios with mutually different accuracies of each sampling algorithm and the performance analysis on expected performance of the algorithm.

When transmitting the tag/Wi-Fi signal in operation S602 described above, the IoT sensor 120 may perform the time-based sampling and the data-based sampling when executing the algorithm.

When transmitting the tag/Wi-Fi signal in operation S602 described above, in the case of the time-based sampling, the IoT sensor 120 may use the time-based sampling algorithm to: operate for X seconds and enter the sleep mode for Y seconds; operate for X1 seconds, be turned off for Y1 seconds, and be turned on for X2 seconds until Xn; or receive a random value for N seconds regardless of Yn.

When transmitting the tag/Wi-Fi signal in operation S602 described above, in the case of the data-based sampling, the IoT sensor 120 may use the data-based sampling algorithm to perform the determination related to the X and Y based on the data found during the N detection round, and to reduce, for example, to Z % when a significant change is detected based on the previous number of tag/Wi-Fi signal generators 110 during the final activation time.

When transmitting the tag/Wi-Fi signal in operation S602 described above, the IoT sensor may receive the Wi-Fi signal and transmit the response message when the tag/Wi-Fi signal generator 110 transmits the Wi-Fi signal for each of the channels 1 to 13 to use the network 140, and may perform the communication with the tag/Wi-Fi signal generator 110 when the tag/Wi-Fi signal generator 110 selects one channel.

When transmitting the tag/Wi-Fi signal in operation S602 described above, the IoT sensor 120 may collect signals by changing the channels (e.g., 1, 5, 9, 13, 2, 6, etc.) in order to sense the signal of the tag/Wi-Fi signal generator 110, and may process and integrate replicated data per unit time including information on the MAC address, the chip manufacturer, the time, and the like in the collected data into a desired data form to transmit the data to the LMS unit 130. In addition, the IoT sensor 120 may periodically transmit the survival signal (including information on the temperature, the memory usage, the CPU usage, etc.) to the database of the LMS unit 130 to determine whether the IoT sensor 120 has an abnormality.

When transmitting the tag/Wi-Fi signal in operation S602 described above, as the IoT sensor 120 detects the wireless signal transmitted from the tag/Wi-Fi signal generator 110, the IoT sensor 120 may determine whether the preset data unit time has elapsed, generate a new unit time data set when the data unit time has elapsed, determine whether the data set MAC address is duplicated when the data unit time has not elapsed or after the new unit time data set is generated, return to an initial operation when the data set MAC address is determined to be duplicated while recording detection information in the unit time data set when the data set MAC address is determined not to be duplicated, determine whether the total data set size is equal to or greater than the preset transmission size, and return to the initial operation when the total data set size is not equal to or greater than the preset transmission size while transmitting the recorded detection information to the LMS unit 130 when the total data set size is equal to or greater than the preset transmission size.

When transmitting the tag/Wi-Fi signal in operation S602 described above, the IoT sensor 120 may include the data processing module to prepare the data to be transmitted by processing the collected data, such that the IoT sensor 120 may filter the collected data based on the required time unit and transmit the filtered data without transmitting the entirety of the data collected from the tag/Wi-Fi signal generator 110.

When transmitting the tag/Wi-Fi signal in operation S602 described above, the IoT sensor 120 may collect data having one identical MAC address and analyze the collected data to collect data of a unit of milliseconds or more, that is, the IoT sensor 120 may collect up to thousands of pieces of data having the identical MAC address within one second.

When transmitting the tag/Wi-Fi signal in operation S602 described above, the IoT sensor 120 may include the data transmission module (e.g., LoRa, LTE-M, and NB-IoT modules, etc.) to transmit the collected data to the back-end system through the IoT WAN of the network 140.

When transmitting the tag/Wi-Fi signal in operation S602 described above, the IoT sensor 120 may be proved with the transmission and storage algorithm to extract and transmit only a required data field without transmitting the entirety of the collected data, so that the number of pieces of data transmitted at one time can be increased while consuming the same power and data, and the transmission period (e.g., a unit of 10 seconds) can be determined according to the memory capacity, in which the transmission may be performed regardless of the transmission period (condition) when 1/n of the memory is occupied in consideration of the transmission failure, and the dynamic transmission period may be applied.

When the tag/Wi-Fi signal is transmitted in operation S602 described above, the LMS unit 130 may receive the tag/Wi-Fi signal transmitted from the IoT sensor 120 to monitor the access to the virtual fence and the abnormal behavior of the moving object by using the received tag/Wi-Fi signal (S603).

When monitoring the access to the virtual fence and the abnormal behavior in operation S603 described above, the LMS unit 130 may be provided with the algorithm for analyzing the access to the virtual fence and the abnormal behavior based on the tag/Wi-Fi signal to analyze the access to the virtual fence and the abnormal behavior of the moving object so as to construct a database of analyzed data (i.e., data obtained by analyzing the access to the virtual fence and the abnormal behavior of the moving object), and to perform the real-time monitoring back-end function to analyze big data in the database so as to analyze or predict the mobility of the moving object.

When monitoring the access to the virtual fence and the abnormal behavior in operation S603 described above, in the case of performing the multi-monitoring, the LMS unit 130 may include the multi-sensor equipped with the Wi-Fi signal sensing function as well as the Bluetooth sensing function to simultaneously perform the outside invasion monitoring (security) function as well as the livestock monitoring function by using one sensor infrastructure.

When monitoring the access to the virtual fence and the abnormal behavior in operation S603 described above, the LMS unit 130 may be provided with the real-time tracker including the moving route prediction function to monitor the moving route in real time and analyze the moving pattern with the function of tracking the moving route of livestock (or invader) based on the current location information collected from the IoT sensor 120.

When monitoring the access to the virtual fence and the abnormal behavior in operation S603 described above, the LMS unit 130 may analyze the moving route of the moving object upon moving route prediction so as to extract the moving route pattern. At this time, the LMS unit 130 may use trajectory data mining schemes upon the moving route prediction, and may use the trajectory data clustering-based algorithm, the trajectory data classification-based algorithm, the trajectory association rule-based algorithm, or the like.

When monitoring the access to the virtual fence and the abnormal behavior in operation S603 described above, the LMS unit 130 may use the pattern mining module of the trajectory association rule-based algorithm, which is an algorithm that defines point (or region) information with numerically-high relevance (frequency of simultaneous or continuous occurrence) as association relation and searches for a frequency and relevance for the information, and may use the route prediction module, to analyze frequent moving route patterns of moving objects entering the location while moving in a specific region so as to predict the ‘next visiting location or route’.

When monitoring the access to the virtual fence and the abnormal behavior in operation S603 described above, while the LMS unit 130 extracts the moving route pattern by executing the pattern mining module, the LMS unit 130 may perform the first operation of converting the location of the moving object into a continuous trajectory to determine whether an error occurs and perform the outlier filtering, the second operation of classifying a cluster based on the starting point and the arrival point (or vice versa) by using the FBM scheme, and the third operation of extracting the moving route pattern for each cluster.

When monitoring the access to the virtual fence and the abnormal behavior in operation S603 described above, the LMS unit 130 may use the route prediction model to predict the next visiting location (or estimate the next route) of the moving object by using the moving route pattern extracted as described above.

When monitoring the access to the virtual fence and the abnormal behavior in operation S603 described above, the LMS unit 130 may select and execute an algorithm in which a model has the highest accuracy by using a model such as decision tree, kNN, and DBN as the route prediction model. At this time, the LMS unit 130 may approach a classification issue of estimating the moving route through prediction of the next visiting location based on the moving route pattern extracted through the pattern mining module.

When monitoring the access to the virtual fence and the abnormal behavior in operation S603 described above, upon the execution of the route prediction model, the LMS unit 130 may perform the first operation of dividing the moving route pattern extracted through the pattern mining module into the training set and the test set, the second operation of training the model with the training set and verifying an accuracy of the model with the test set, and the third operation of returning the moving prediction location as a result when the moving location set of the moving object is transmitted as the input variable of the route prediction model.

When monitoring the access to the virtual fence and the abnormal behavior in operation S603 described above, the LMS unit 130 may be provided with the big data analysis module for real-time monitoring to perform real-time data collection, storage, and processing, in which the LMS unit 130 may collect a large amount of scanning data and sensor state information, perform data cleansing, normalization, and verification on the collected data, perform normalization and preprocessing to efficiently process massive data, perform preprocessing on the moving route and the data of the moving object, and extract descriptive statistics of the preprocessed data to obtain real-time route analysis data and moving route prediction data.

When monitoring the access to the virtual fence and the abnormal behavior in operation S603 described above, the LMS unit 130 may visualize the analysis result through the heat map in the real-time monitoring graphs and maps. At this time, the LMS unit 130 may express the analysis result in the heat map and the congestion grid scheme for each sensor, or with the real-time staying object and the moving route analysis.

As described above, the embodiments of the present invention may not be embodied only through the above-described apparatus and/or method, but may be embodied through a program for implementing a function corresponding to the configuration of the embodiment of the present invention, a recording medium on which the program is recorded, and the like. Such implementation may be easily performed by those skilled in the art to which the invention pertains based on the description of the aforementioned embodiments. Although the embodiments of the present invention have been described in detail above, the scope of the present invention is not limited to the embodiments, and various modifications and improvements that are made by those skilled in the art by using the basic concept of the present invention as defined in the appended claims also fall within the scope of the present invention.

What is claimed is:

1. A real-time monitoring system for agriculture and livestock farming by using an IoT sensor, the real-time monitoring system comprising:
a tag/Wi-Fi signal generator installed on a moving object to generate a tag/WiF-i signal;
an IoT(Internet of Things) sensor for detecting the tag/Wi-Fi signal generated by the tag/Wi-Fi signal generator; and
a LMS(Livestock Monitoring System) unit for receiving the tag/Wi-Fi signal detected by the IoT sensor to monitor access to a virtual fence and an abnormal behavior of the moving object.

2. The real-time monitoring system of claim 1, wherein the tag/Wi-Fi signal generator includes a BLE (Bluetooth Low Energy) tag for tracking the moving object based on BLE 4.2 or higher.

3. The real-time monitoring system of claim 1, wherein the tag/Wi-Fi signal generator includes a Wi-Fi module for generating a Wi-Fi signal.

4. The real-time monitoring system of claim 3, wherein the tag/Wi-Fi signal generator operates in one or more schemes among: a scheme of transmitting multiple messages per second while the tag/Wi-Fi signal generator is connected to a Wi-Fi network; a scheme of attempting to search for the Wi-Fi network by a unit of a preset time while the tag/Wi-Fi signal generator is not connected to the Wi-Fi network; a scheme of attempting to search for a nearby IoT sensor and transmitting a signal for the searching every preset time when a location service is activated; and a scheme of randomly changing a MAC (Media Access Control) address every preset time or whenever a significant change is detected in an environment.

5. A real-time monitoring method for agriculture and livestock farming by using an IoT sensor, the real-time monitoring method comprising:
generating a tag/Wi-Fi signal by a tag/Wi-Fi signal generator installed on a moving object;
detecting, by an IoT sensor, the tag/Wi-Fi signal generated by the tag/Wi-Fi signal generator; and
receiving, by an LMS unit, the tag/Wi-Fi signal detected by the IoT sensor to monitor access to a virtual fence and an abnormal behavior of the moving object.
